(19) United States
(12) Patent Application Publication
(10) Pub. No.: US 2022/0087240 A1
(43) Pub. Date: Mar. 24, 2022

(54) Fishing Lure

(71) Applicants: Dong Ha Kim, Gyeonggi-do (KR); Woo Joong Hong, Gyeonggi-do (KR)

(72) Inventors: Dong Ha Kim, Gyeonggi-do (KR); Woo Joong Hong, Gyeonggi-do (KR)

(21) Appl. No.: 17/389,687

(22) Filed: Jul. 30, 2021

(30) Foreign Application Priority Data
Sep. 24, 2020 (KR) 10-2020-0123521

(51) Int. Cl. A01K 85/00; A01K 95/00

(52) U.S. Cl. CPC A01K 85/00; A01K 95/00

(57) ABSTRACT

Provided is a fishing lure including: a main body unit elongated in one direction; and a lip unit provided at one end of the main body unit and connected to a fishing line, in which the lip unit is inclined with respect to a longitudinal direction of the main body unit so that an angle at which the main body unit is raised is adjusted in accordance with resistance of water that occurs as the fishing line is pulled.

### CROSS-REFERENCE TO RELATED APPLICATIONS

This application claims priority to and the benefit of Korean Patent Application No. 10-2020-0123521 filed in the Korean Intellectual Property Office on Sep. 24, 2020, the entire contents of which are incorporated herein by reference.

### TECHNICAL FIELD

The present disclosure relates to a fishing lure, and more particularly, to a fishing lure capable of adjusting a speed at which a main body unit sinks after the main body unit is raised at a large angle when a fishing line is pulled in accordance with an angle between the main body unit and a lip unit.

### BACKGROUND ART

There are various methods of catching fishes by fishing. There are applied various methods such as float fishing using floats, live bait fishing using live baits, boat fishing performed on boats, paste bait fishing using paste baits, and lure fishing using lures.

In the case of the fishing using the lure, a method of allowing the lure to sink to catch a fish existing at a depth from a water surface is used, and a user sways the lure to attract the fish after the lure reaches the bottom. When the lure is a type of sinking, when the user moves the lure, the lure is raised to the water surface when the user moves the lure, whereas the lure sinks again when the user stops moving the lure. When the lure is a type of floating, when the user moves the lure, the lure sinks downward from the water surface when the user moves the lure, whereas the lure floats again when the user stops moving the lure.

When the lure rises, the larger the rising angle, the better the ability to attract a target fish, the higher the probability of reducing the situation in which the lure is caught at the bottom, and the higher the probability of encountering the target fish because precise search is enabled. When the lure sinks, the slower the speed at which the lure sinks, the longer the time for attracting the target fish, and the higher the probability that the target fish bites the lure. There is applied a method different from a method of catching a fish positioned close to the water surface with a wavelength and sound generated on the water surface by the rise-type lure.

In a case in which the sinking-type lure in the related art is used to catch the fish existing at a depth from the water surface, the lure is raised at a small angle when the user pulls the lure on the bottom, and the lure is frequently caught at the bottom, and as a result, the fishing line is abraded and cut. For this reason, the user cannot take the lure out of the water and needs to use a new lure.

When the user tries to take the lure out of the water by pulling the fishing line after dropping the lure into the water, the sinking-type lure is raised at a small angle because the sinking-type lure cannot sufficiently receive resistance of water, and as a result, there is a drawback in that the lure is frequently caught at the bottom.

Because the lure is raised at a small angle as the fishing line is pulled, a movement distance in a transverse direction is increased, and a height by which the lure is raised is decreased, which causes a drawback in that precise search within a wide area cannot be performed.

Therefore, various means have been proposed to improve efficiency in performing precise search within a wide area and attracting fishes while preventing the lure from being caught at the bottom, and there is a need for means for solving the above-mentioned drawbacks.

### SUMMARY OF THE INVENTION

The present disclosure has been made in an effort to provide a fishing lure capable of raising a main body unit at a large angle when a fishing line is pulled in accordance with an angle between the main body unit and a lip unit.

Technical problems of the present disclosure are not limited to the aforementioned technical problems, and other technical problems, which are not mentioned above, may be clearly understood by those skilled in the art from the following descriptions.

In one aspect, the present disclosure provides a fishing lure including: a main body unit elongated in one direction; and a lip unit provided at one end of the main body unit and connected to a fishing line, in which the lip unit is inclined with respect to a longitudinal direction of the main body unit so that an angle at which the main body unit is raised is adjusted in accordance with resistance of water that occurs as the fishing line is pulled.

When a direction in which the lip unit is raised as the fishing line is pulled is defined as an upward direction, the lip unit may be inclined such that a distance between an upper side of the lip unit and the main body unit is relatively longer than a distance between a lower side of the lip unit and the main body unit based on one end of the lip unit coupled to the main body unit.

When an imaginary line connecting one end of the upper side and the other end of the lower side is defined as a first line and an imaginary line parallel to the longitudinal direction of the main body unit is defined as a second line, the lip unit may be inclined such that an angle between the first line and the second line is 45 to 90 degrees.

The lip unit may have a larger cross-sectional shape than the main body unit to increase an angle at which the main body unit is raised by increasing the resistance of the water when the fishing line is pulled.

The main body unit may include: a load adjusting part configured to adjust a gradient of the main body unit by changing a center of gravity in the main body unit; and an insertion part into which a weight is inserted to provide a load so that the main body unit sinks in the water.

The load adjusting part may include: a rail member elongated in the longitudinal direction of the main body unit; and a weight member coupled to the rail member and configured to move on the rail member and provide a weight so that the center of gravity of the main body unit is adjusted in accordance with a position of the weight member.

The rail member may be formed in a tubular shape so that the weight member moves on the rail member, and one end of the rail member may be bent toward a lower portion of the main body unit.

The rail member may be inclined downward so that the weight member is positioned on the lower portion of the main body unit in a state in which no external force is applied.

The insertion part may have a plurality of spaces formed in a lower portion of the main body unit so that a plurality of weights is inserted into the plurality of spaces.

A coupling part to which a fishing hook is coupled may be provided on an upper portion of the main body unit in order to prevent the main body unit from being caught at the bottom of the water.

According to the fishing lure according to the present disclosure provided to achieve the object, the main body unit may be raised at a large angle when the fishing line is pulled in accordance with an angle between the main body unit and the lip unit, and a speed at which the main body unit is lowered after the main body unit is raised may be adjusted.

### BRIEF DESCRIPTION OF THE DRAWINGS

A detailed description of the exemplary embodiments of the present application to be described below as well as the summary explained above will be understood well when reading the detailed description and the summary with reference to the accompanying drawings. The exemplary embodiments are illustrated in the drawings for the purpose of exemplifying the present disclosure. However, it should be understood that the present application is not limited to the illustrated exact arrangement and means.

FIG. 1 is a view illustrating an overall appearance of a fishing lure according to an embodiment of the present disclosure.

FIG. 2 is a view for comparing cross sections of a main body unit and a lip unit of the fishing lure according to the embodiment of the present disclosure.

FIG. 3 is a view for explaining a situation in which a fishing line of the fishing lure according to the embodiment of the present disclosure is pulled.

FIG. 4 is a view for explaining an angle at which the main body unit of the fishing lure according to the embodiment of the present disclosure is raised.

FIG. 5 is a view for explaining a situation in which the fishing lure according to the embodiment of the present disclosure is lowered.

FIG. 6 is a view for explaining a weight member of the fishing lure according to the embodiment of the present disclosure.

FIG. 7 is a view for explaining a movement distance of the fishing lure according to the embodiment of the present disclosure.

FIG. 8 is a view for explaining a cross-sectional shape of the lip unit of the fishing lure according to the embodiment of the present disclosure.

### DETAILED DESCRIPTION

Hereinafter, exemplary embodiments of the present disclosure for specifically accomplishing the objects of the present disclosure will be described with reference to the accompanying drawings. In the description of the present embodiments, like terms and like reference numerals are used for like configurations, and additional descriptions for the like configurations will be omitted.

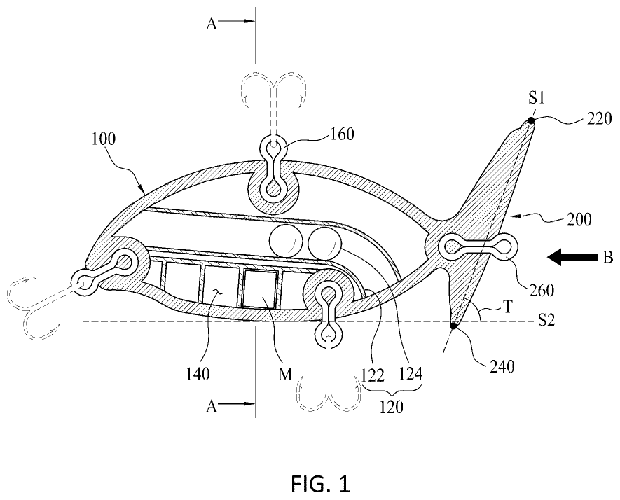

First, an overall configuration of a fishing lure according to an embodiment of the present disclosure will be described with reference to FIG. 1.

Specifically, FIG. 1 is a view illustrating an overall appearance of the fishing lure according to the embodiment of the present disclosure.

First, as illustrated in FIG. 1, the fishing lure according to the embodiment of the present disclosure may include a main body unit 100 elongated in one direction, and a lip unit 200 provided at one end of the main body unit 100 and connected to a fishing line L.

In this case, the main body unit 100 may be elongated in a direction in which the main body unit 100 is moved as the fishing line L is pulled. The main body unit 100 may be elongated in a transverse direction instead of an upward/downward direction in which the main body unit 100 is pulled and raised.

This minimizes resistance of the water that occurs when the main body unit 100 is pulled. As a result, it is possible to prevent a situation in which a fish caught by a fishing hook is missed as the main body unit 100 coupled to the fishing hook is swayed by the resistance of the water. Further, it is possible to prevent a situation in which the lip unit 200 sways due to the swaying of the main body unit 100 and thus cannot appropriately receive the resistance of the water.

The main body unit 100 may include a load adjusting part 120 configured to adjust a gradient of the main body unit 100 by adjusting a center of gravity in the main body unit 100, an insertion part 140 configured to provide a space into which a weight M may be inserted to provide a weight so as to adjust a speed at which the main body unit 100 sinks in the water, and a coupling part 160 to which the fishing hook is coupled.

In this case, the load adjusting part 120 may include a rail member 122 elongated in a longitudinal direction of the main body unit 100, and a weight member 124 configured to move on the rail member and provide a weight.

In this case, the rail member 122 may have a tubular shape so that the weight member 124 is inserted into the rail member 122. One side of the rail member 122 may be inclined at a predetermined angle toward a lower portion of the main body unit 100.

When a user throws the main body unit 100 toward the water using a fishing rod, the weight member 124 is moved in a direction away from the lip unit 200 by inertia to adjust a center of gravity of the main body unit 100. Thereafter, when the main body unit 100 sinks in the water, the weight member 124 may be positioned at the lower portion of the main body unit 100 by the angle of the rail member 122.

In order to prevent the weight member 124 from being excessively moved in the main body unit 100 by inertia, one end of the rail member 122 may be bent toward the lower portion of the main body unit 100, thereby minimizing the motion of the weight member 124.

Meanwhile, the weight member 124 is moved on the rail member 122 by inertia to adjust the center of gravity of the main body unit 100.

For example, when the user throws the main body unit 100 toward the water as described above, the weight member 124 is moved by inertia in the main body unit 100 in the direction away from the lip unit 200, such that the main body unit 100 may be dropped at a position distant from the user.

Meanwhile, the insertion part 140 may provide the space into which the weight M is inserted, and the weight M provides a load to the main body unit 100 together with the weight member 124 so that the main body unit 100 may sink in the water.

The plurality of insertion parts 140 may be provided in the longitudinal direction of the main body unit 100 so that the plurality of the weights M may be inserted into the insertion parts 140 in accordance with the user's convenience to adjust a speed at which the main body unit 100 sinks.

The plurality of coupling parts 160 to which the fishing hook may be coupled may be provided around the main body unit 100. The coupling parts 160 may be provided to be coupled to an upper portion of the main body unit 100 as well as the lower portion and the other end of the main body unit 100. In order to prevent the fishing hook from being caught by a rock or the bottom when the fishing is performed in a state in which the lure is positioned close to the bottom as necessary, the fishing hook may be coupled only to the coupling part 160 provided on the upper portion of the main body unit 100.

Meanwhile, the lip unit 200 is provided at one end of the main body unit 100 and may be provided to be spaced apart from the main body unit 100 at a predetermined angle in the longitudinal direction of the main body unit 100.

That is, the lip unit 200 may be inclined so as to define a predetermined angle with respect to the longitudinal direction of the main body unit 100. Therefore, it is possible to increase an angle at which the main body unit 100 is raised by receiving the resistance of the water when the main body unit 100 is pulled.

A direction in which the main body unit 100 is raised as the user pulls the fishing line L is defined as an upward direction, one end at an upper side of the lip unit 200 is defined as a first point 220, and the other end at a lower side of the lip unit 200 is defined as a second point 240. In this case, the lip unit 200 is provided such that a distance between the first point 220 and the main body unit 100 is relatively longer than a distance between the second point 240 and the main body unit 100. As a result, the lip unit 200 may be provided at one end of the main body unit 100 in the state in which the lip unit 200 is inclined at a preset angle.

When the lip unit 200 is provided to be inclined at a preset angle with respect to the main body unit 100 as described above, the lip unit 200 receives the resistance of the water, as the fishing line L is pulled, while leaving the resistance of the water at a lower portion of the lip unit 200, and as a result, an angle at which the main body unit 100 is raised is increased.

Meanwhile, a protruding portion may protrude by a predetermined distance from a central portion of the lip unit 200 to prevent resistance of air and resistance of water, which occur when the user pulls the fishing line L or the user throws the main body unit 100 toward the water, from exceeding a predetermined level and interrupting the falling of the main body unit 100 and the rising of the main body unit 100.

A connection part 260 to which the fishing line L may be coupled may be provided on the central portion of the lip unit 200 in order to increase an angle at which the main body unit 100 is raised as the resistance of the water is applied to the lip unit 200 when the main body unit 100 is pulled by the fishing line L.

As illustrated in FIG. 1, a first imaginary line S1 connecting the first point 220 and the second point 240 is defined, and a second imaginary line S2 parallel to the longitudinal direction of the main body unit 100 is defined, and a preset angle T may be defined between the first line S1 and the second line S2.

In this case, the preset angle T may be an angle relatively smaller among the angles defined between the mathematically imaginary two lines S1 and S2. This may be apparent because the angle between the mathematically imaginary two lines will be described as being a relatively small angle.

In order to make the resistance of the water eccentric toward the lower portion of the main body unit 100 and increase the angle at which the main body unit 100 is raised, the preset angle T may be set to be 45 to 90 degrees to prevent the resistance of the water from being applied to the main body unit 100 and make the resistance of the water eccentric toward the lower portion of the main body unit 100.

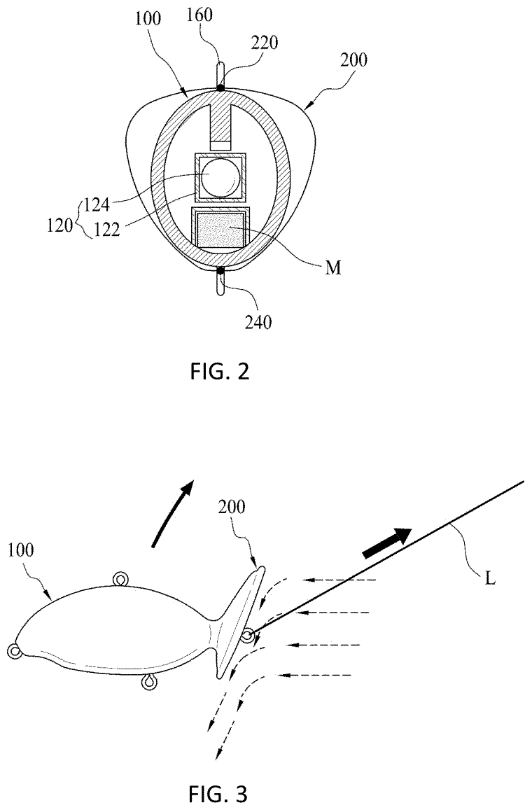

With the above-mentioned configuration, a situation in which the fishing lure according to the embodiment of the present disclosure is used will be described with reference to FIGS. 2 to 7.

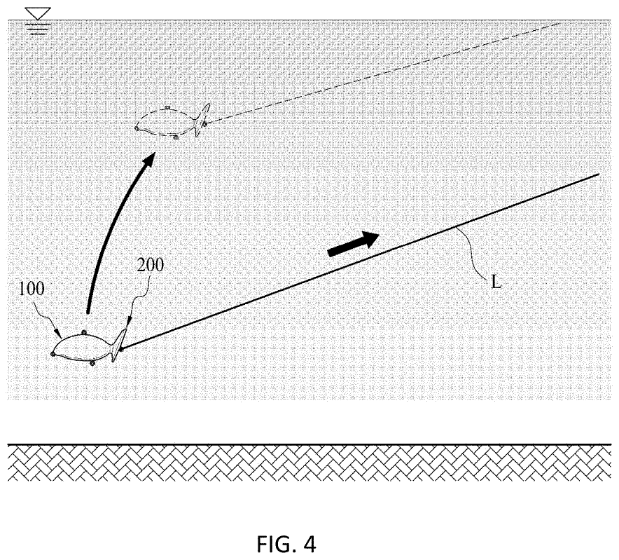

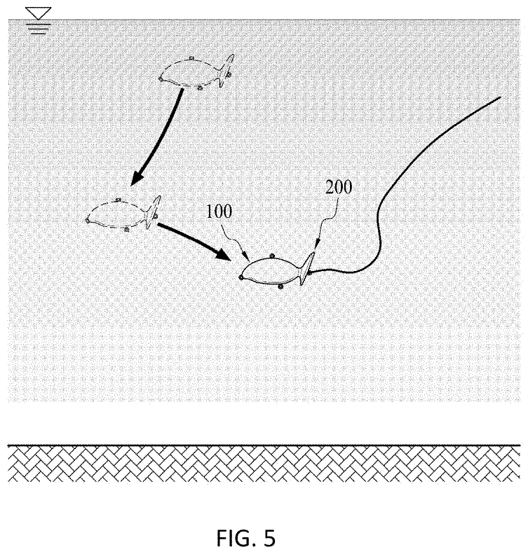

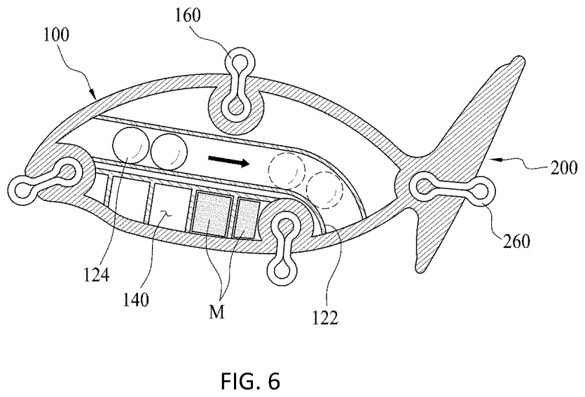

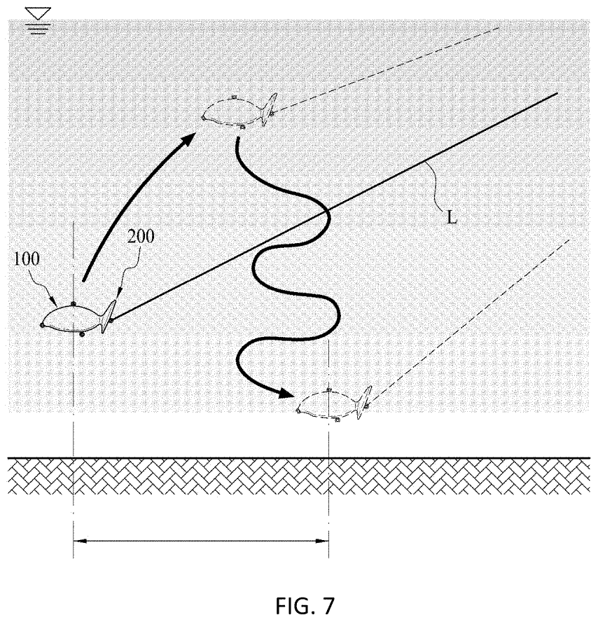

Specifically, FIG. 2 is a view for comparing cross sections of the main body unit and the lip unit of the fishing lure according to the embodiment of the present disclosure, FIG. 3 is a view for explaining a situation in which the fishing line of the fishing lure according to the embodiment of the present disclosure is pulled, FIG. 4 is a view for explaining an angle at which the main body unit of the fishing lure according to the embodiment of the present disclosure is raised, FIG. 5 is a view for explaining a situation in which the fishing lure according to the embodiment of the present disclosure is lowered, FIG. 6 is a view for explaining the weight member of the fishing lure according to the embodiment of the present disclosure, and FIG. 7 is a view for explaining a movement distance of the fishing lure according to the embodiment of the present disclosure.

First, as illustrated in FIG. 2, a cross section of the main body unit 100 taken in direction A in FIG. 1 and a shape of the lip unit 200 viewed in direction B are compared. The lip unit 200 may have a relatively larger cross-sectional area than the main body unit 100. In terms of the cross-sectional shapes taken along the second line S2, the lip unit 200 may also have a larger cross-sectional area than the main body unit 100.

The above-mentioned difference in cross-sectional area allows the main body unit 100 to relatively less receive the resistance of the water and increases the resistance of the water applied to the lip unit 200, thereby increasing an angle at which the main body unit 100 is raised while pulling the fishing line L.

Meanwhile, as illustrated in FIG. 2, the rail member 122 may be provided in the form of a tube having a quadrangular cross-sectional shape, but the present disclosure is not limited thereto, and the rail member 122 may have various shapes such as a circular shape or an elliptical shape as long as the weight member 124 may move inside the rail member 122.

In the case in which the fishing line L is pulled as illustrated in FIG. 3, the user at a relatively high position pulls the fishing line L, such that the fishing line L may be pulled by a force applied upward in a direction inclined with respect to the longitudinal direction of the main body unit 100 and the lip unit 200 may receive the resistance of the water while being moved by the fishing line L.

In this case, since the lip unit 200 is inclined at the preset angle T such that the distance between the first point 220 and the main body unit 100 is relatively longer than the distance between the second point 240 and the main body unit 100, the water, which collides with the upper side of the lip unit 200, moves downward, such that the angle at which the main body unit 100 is raised may be increased.

That is, when the fishing line L is pulled as illustrated in FIG. 4, the main body unit 100 is raised at a large angle, such that it is possible to prevent the fishing hook from being caught by a rock or a gap existing on the bottom of the water.

Meanwhile, the weight member 124, which has been moved in the direction away from the lip unit 200 when the user drops the main body unit 100 toward the water, moves to a front side by the angle of the rail member 122 after the main body unit 100 is dropped into the water. As a result, the center of gravity of the main body unit 100 is positioned to slightly deviate from the middle portion, such that the main body unit 100 is lowered with a slight inclination, which may more effectively attract the target fish in comparison with the case in which the main body unit 100 is lowered straight.

When the user fixes the fishing line L, the main body unit 100 is instantaneously stopped at a limit point by the restriction of the length of the fishing line L, as illustrated in FIG. 6. Therefore, the weight member 124 in the main body unit 100 is automatically moved by inertia and gradient toward the lip unit 200 direction, such that the main body unit 100 may sink again toward the position of the user.

Since the rail member 122 is inclined at a predetermined angle toward the lower portion of the main body unit 100, the main body unit 100 may be moved toward the position of the user by the movement of the weight member 124 by the inclination of the rail member 122 in addition to the inertia by the restriction of the length of the fishing line L.

When the main body unit 100 is moved toward the position of the user by the weight member 124 as described above, the main body unit 100 sinks at a predetermined angle while rotating and moving in the direction away from the user, the direction toward the user, the right direction, and the left direction, as illustrated in FIG. 5, from the moment when the main body unit 100 falls into the water. Therefore, it is possible to improve vividness of the main body unit 100, attract the fishes, and improve fishing efficiency.

When the fishing line L is pulled as illustrated in FIG. 7, the main body unit 100 is raised at a large angle while being moved and rotated by the lip unit 200, and a distance by which the main body unit 100 substantially moves relatively decreases based on the bottom. When the pulling of the fishing line L is stopped, the main body unit 100 is lowered as described above, thereby enabling search with high density.

If the lip unit 200 is manufactured based on the related art, the lip unit 200 is provided in parallel with the longitudinal direction of the main body unit 100 or provided below the main body unit 100. Therefore, when the fishing line L is pulled, the resistance of the water is applied directly to the main body unit 100, the lip unit 200 cannot sufficiently receive the resistance of the water when the user pulls the fishing line L, and the main body unit 100 is raised at a small angle. As a result, there is a problem in that the fishing hook coupled to the main body unit 100 is frequently caught at the bottom.

The lip unit 200 manufactured based on the related art is provided in parallel with the longitudinal direction of the main body unit 100 or provided below the main body unit 100 in order to make an action of the main body unit 100 that sways under the water surface. After the main body unit 100 is lowered, the main body unit 100 receives lower resistance than the lip unit 200, and as a result, there is also a problem in that the main body unit 100 cannot float at a large angle.

Therefore, since the lip unit 200 according to the embodiment of the present disclosure is inclined at the preset angle T with respect to the main body unit 100, the angle at which the main body unit 100 is raised is increased by the resistance of the water when the fishing line L is pulled, and as a result, the main body unit 100 is prevented from being caught at the bottom. When the main body unit 100 is lowered, the main body unit 100 is moved in the direction in which the main body unit 100 is positioned, that is, the direction toward the user, such that the weight member 124 inside the main body unit 100 is moved along the rail member 122 and positioned close to the lip unit 200 based on the center based on the longitudinal direction of the main body unit 100, thereby preventing the main body unit 100 from being inclined.

Since the angle at which the main body unit 100 is raised is increased, a movement distance on a substantial horizontal surface is decreased, and thus fishing efficiency may be improved by search with higher density.

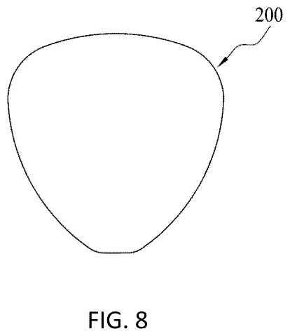

Meanwhile, since the resistance of the water applied to the upper portion of the lip unit 200 is transmitted to the lower portion of the lip unit 200 by the gradient of the lip unit 200 and raises the main body unit 100, the resistance of the water applied to the upper side of the lip unit 200 is relatively larger than the resistance of the water applied to the lower side of the lip unit 200. As a result, as illustrated in FIG. 8, a diameter of the lip unit 200 may be changed from the upper portion to the lower portion of the lip unit 200 in order to increase the angle at which the main body unit 100 is raised.

That is, as illustrated in FIG. 8, the lip unit 200 is provided in a shape close to an inversed triangular shape so that the lower side of the lip unit 200 has a relatively small diameter, such that the resistance of the water applied to the upper side is different from the resistance of the water applied to the lower side, and as a result, it is possible to increase the angle at which the main body unit 100 is raised.

Therefore, it is possible to prevent the fishing hook coupled to the main body unit 100 from being caught at the bottom and achieve search with high density.

In order to prevent the main body unit 100 from being caught at the bottom, the coupling part 160, to which the fishing hook may be coupled, is provided on the upper portion of the main body unit 100 so that the fishing hook may be used, instead of two lower hooks, at a location where the main body unit 100 is highly likely to be caught at the bottom. As a result, it is possible to additionally prevent the fishing hook from being caught by a rock or a stone even though the main body unit 100 sinks on the bottom, thereby preventing an accident in which the main body unit 100 is caught at the bottom and the fishing line L is cut and lost.

As necessary, when the main body unit 100 floats in the water without being completely placed on the bottom, the necessity of coupling the fishing hook only to the upper portion of the main body unit 100 is low. Therefore, the plurality of the coupling parts 160 may be provided around the main body unit 100 so that the plurality of fishing hooks may be coupled to the plurality of the coupling parts 160, as necessary.

While the exemplary embodiments according to the present disclosure have been described above, it is obvious to those skilled in the art that the present disclosure may be specified in other particular forms in addition to the aforementioned embodiments without departing from the spirit or the scope of the present disclosure. Accordingly, it should be understood that the aforementioned embodiments are not restrictive but illustrative, and thus the present disclosure is not limited to the aforementioned description and may be modified within the scope of the appended claims and the equivalent range thereto.

What is claimed is:

1. A fishing lure comprising:
a main body unit elongated in one direction; and
a lip unit provided at one end of the main body unit and connected to a fishing line,
wherein the lip unit is inclined with respect to a longitudinal direction of the main body unit so that an angle at which the main body unit is raised is adjusted in accordance with resistance of water that occurs as the fishing line is pulled.

2. The fishing lure of claim 1, wherein when a direction in which the lip unit is raised as the fishing line is pulled is defined as an upward direction, the lip unit is inclined such that a distance between an upper side of the lip unit and the main body unit is relatively longer than a distance between a lower side of the lip unit and the main body unit based on one end of the lip unit coupled to the main body unit.

3. The fishing lure of claim 2, wherein when an imaginary line connecting one end of the upper side and the other end of the lower side is defined as a first line and an imaginary line parallel to the longitudinal direction of the main body unit is defined as a second line, the lip unit is inclined such that an angle between the first line and the second line is 45 to 90 degrees.

4. The fishing lure of claim 1, wherein the lip unit has a larger cross-sectional shape than the main body unit to increase an angle at which the main body unit is raised by increasing the resistance of the water when the fishing line is pulled.

5. The fishing lure of claim 1, wherein the main body unit comprises:
a load adjusting part configured to adjust a gradient of the main body unit by changing a center of gravity in the main body unit; and
an insertion part into which a weight is inserted to provide a load so that the main body unit sinks in the water.

6. The fishing lure of claim 5, wherein the load adjusting part comprises:
a rail member elongated in the longitudinal direction of the main body unit; and
a weight member inserted into the rail member and configured to move on the rail member and provide a weight so that the center of gravity of the main body unit is adjusted in accordance with a position of the weight member.

7. The fishing lure of claim 6, wherein the rail member is formed in a tubular shape, the weight member moves on the rail member, and one end of the rail member is bent toward a lower portion of the main body unit.

8. The fishing lure of claim 7, wherein the rail member is inclined downward so that the weight member is positioned on the lower portion of the main body unit in a state in which no external force is applied.

9. The fishing lure of claim 5, wherein the insertion part has a plurality of spaces formed in a lower portion of the main body unit so that a plurality of weights is inserted into the plurality of spaces.

10. The fishing lure of claim 1, wherein a coupling part to which a fishing hook is coupled is provided on an upper portion of the main body unit in order to prevent the main body unit from being caught at the bottom.

11. A method for fishing, the method comprising suspending the fishing lure of claim 1 from the fishing line within a body of water containing fish.
